(19) United States
(12) Patent Application Publication
(10) Pub. No.: US 2005/0225085 A1
(43) Pub. Date: Oct. 13, 2005

(54) Coupler for an air temperature control

(76) Inventors: Todd A. Markward, Van Wert, OH (US); Scott D. Gill, Fort Wayne, IN (US); Jeffrey D. Gleckler, Convoy, OH (US)

Correspondence Address: Joseph J. Pophal, 6035 Parkland Boulevard, Cleveland, OH, 44124-4141, US

(21) Appl. No.: 11/101,889

(22) Filed: Apr. 8, 2005

Related U.S. Application Data
(60) Provisional application No. 60/560,523, filed on Apr. 8, 2004.

(51) Int. Cl. F16L 19/00

(52) U.S. Cl. 285/374

(57) ABSTRACT

Improvement in a coupler for an air temperature control system in the form of a coupling adaptor interposed between a known tapered end male connector and a known female coupling including a line set with a pre-charged refrigerant medium at one end and a metallic diaphragm seal on another end, the adaptor comprising: a first portion having a first central cavity including an inwardly-directed portion having a peripheral knife edge; and a second, adjoining, portion, having a second central cavity communicating with the first central cavity, a diaphragm cutter, proximate to the first portion and extending into the second portion, the second cavity also including a distal annular nose portion and an internal peripheral groove, retaining an elastomeric seal, between the nose portion and the diaphragm cutter, and a diaphragm interposed between the diaphragm cutter and the seal. A method of assembling the noted coupler is also set forth.

### CROSS-REFERENCE TO RELATED CASES

The present invention claims the benefit of the filing date of U.S. Provisional Application Ser. No. 60/560,523, filed Apr. 8, 2004, the disclosure of which is incorporated herein by reference.

### FIELD OF THE INVENTION

The present invention pertains to couplers used in air temperature, such as refrigeration/air conditioning, systems, e.g., for residential and industrial usage, with a typical coupler being generally comprised of a male SAE 45 degree flare connector, and a female coupling, having a an attached pre-charged line set, with the flare connector and the female coupling being operatively interconnected via the interposed coupling adaptor of the present invention.

### BACKGROUND OF THE INVENTION

Couplers for air temperature control systems are well known, with a typical prior art structure being illustrated in FIGS. 1a to 3b. Specifically, as shown therein, prior art coupling 20 is comprised of a generally tubular, known, male, SAE 45 degree metallic flare connector 22, shown in detail in FIGS. 1a and 1b, and a generally tubular, known, coupling adaptor, shown in FIGS. 2a and 2b, comprised of a metallic nut 26 and a copper tube 28. Tube 28 is provided, on the end adapted to be received within nut 26, with a flared end portion 32, which in turn is adapted to be sealingly interposed or sandwiched between the 45 degree flared portion surface 30 of flare connector 22 and an inside shoulder 34 of nut 26, upon the assembly of flare connector 22 and coupling adaptor 24, as best illustrated in FIG. 3b. Copper tube or tubing 28 is used as a line set 36 that receives a refrigerant medium which however first requires evacuation and subsequent charging of tube 28.

In a manner well known in the art, due to the use of standard or typical flare connections, requiring malleability of the tubing material, only line sets of copper tubing could be utilized. A serious obstacle of this prior art practice is that each line set thus requires the actual physical shaping of the front or leading edge of the tubing into a flared portion, as already described hereinabove. Thereafter, the tubing must be evacuated of all debris, if present, and all fluid media and the connected assembly must be subsequently charged with a refrigerant medium after mechanically connecting the line with the noted male flare connector.

The patent literature includes a large number of couplers and/or coupling devices that find utility in the air temperature control art. Included in this art are: U.S. Pat. No. 3,093,979 to Ehrens et al.; U.S. Pat. No. 3,561,726 to Iannelli; U.S. Pat. No. 4,069,686 to Hoelman; U.S. Pat. No. 4,338,793 to O'Hern, Jr.; U.S. Pat. No. 6,266,971 B1 to Schroder et al.; U.S. Pat. No. 6,385,986 B1 to Ferris, et al; and Japanese Patent No. JP 06313499 A to Yagi. However, none of the prior art structures, set forth in the noted references, pertain to the improved coupler, the unique coupling adaptor, and the method of assembling the coupling, of the present invention.

### SUMMARY OF THE INVENTION

Accordingly, in order to overcome the deficiencies of the prior art devices, the present invention provides an improved coupler, a unique coupling adaptor as well as a method of assembling the coupling.

Specifically, in terms of structure, in a coupler for air temperature control systems, having an axially apertured, generally cylindrical, metallic male connector with two ends and a flared surface portion on one end; an axially apertured, generally cylindrical, metallic female coupling having two ends, with a line set pre-charged with a gaseous medium at one end; a diaphragm seal for retaining the gaseous medium at a distal portion of the another end, the another end also including a generally tubular portion and a plurality of concentric annular steps at a proximate portion thereof, the another end also having a rotatable nut member secured to and coaxial with the another end, the improvement comprises: a generally tubular, metallic coupling adaptor, operatively connected between the male connector and the female coupling, the coupling adaptor including: i. a female portion having a coaxial multi-bore first cavity, the first cavity including an annular, radially inwardly-directed shoulder portion having a peripheral knife edge, the male connector one end, together with the flared surface portion, being operatively interconnected with the female portion first cavity, the flared surface portion impinging upon and sealingly embedding the knife edge therein, thereby providing a fluid-tight metal-to-metal seal between the male connector and the female portion; and the coupling adaptor further including: ii. a male portion, adjoining one end of the female portion, having a multi-bore second cavity, coaxial and in communication with the multi-bore first cavity, a central diaphragm cutter extending axially into the multi-bore second cavity, proximate the one end of the female portion, the male portion also including a distal, flared, annular nose portion, the multi-bore second cavity including an internal peripheral groove, located between the diaphragm cutter and the nose portion; an elastomeric sealing member retained in the peripheral groove; and a diaphragm interposed within the multi-bore second cavity, between the diaphragm cutter and the elastomeric sealing member; the female coupling having an operative interconnection with the male portion multi-bore second cavity, the interconnection including: the elastomeric sealing member achieving a sealing relationship with the generally tubular portion of the female coupling another end; the annular flared nose portion of the coupling adaptor male portion impinging upon and sealingly embedding at least one of the female coupling annular steps, thereby providing a fluid-tight metal-to-metal seal between the coupling adaptor male portion and the female coupling; and the female coupling one end, together with the diaphragm seal, impinging upon the coupling adaptor diaphragm, contacting the diaphragm cutter and successively piercing the coupling adaptor diaphragm and the female coupling diaphragm seal, thereby permitting the subsequent flow of the pre-charged gaseous medium into the coupling adaptor and the male connector.

In one variation, the coupling adaptor male portion includes an external fastening member and the female coupling rotatable member includes an internal fastening member, with the joining of the fastening members providing the operative interconnection between the female coupling and the male portion multi-bore second cavity.

In another variation, the male connector one end includes an external fastening member and the coupling adapter female portion multi-bore first cavity includes an internal fastening member, with the joining of the fastening members operatively interconnecting the first cavity with the male connector one end.

In a further variation, the diaphragm is a metallic diaphragm.

A further embodiment of this invention pertains to a generally tubular coupling adaptor operatively interconnected between a generally tubular male connector, having a flared surface portion on one end, and a generally tubular female coupling, having two ends, with one generally cylindrical end being sealed with a metallic diaphragm, another end being operatively connected with a line set pre-charged with a gaseous medium and, intermediate the two ends, having at least one exterior annular stepped portion, the coupling adaptor comprising: a first portion having a first central cavity, the first cavity including an annular, radially-inwardly-directed shoulder portion having a peripheral knife edge, the male connecter flared surface portion being operatively interconnected with the first portion first cavity, the peripheral knife edge being sealingly embedded within the flared surface portion, thus providing a fluid-tight metal-to-metal seal between the male connector and the first portion; and a second portion, adjoining one end of the first portion, having a second central cavity in communication with the first cavity, a diaphragm cutter, proximate the first portion, axially extending into the second cavity, the second portion also including a distal, flared, annular nose portion, and an internal peripheral groove, intermediate the diaphragm cutter and the nose portion; an elastomeric sealing member retained within the peripheral groove; and a diaphragm interposed within the second central cavity between the diaphragm cutter and the sealing member, the female coupling having an operatively sealed interconnection with the second portion second central cavity via the sealing member having a sealing relationship with the generally cylindrical end of the female coupling; with the flared, annular nose portion being sealingly embedded in the at least one exterior annular stepped portion, thereby providing a metal-to-metal seal between the second portion and the female coupling; and the female coupling one end, together with the diaphragm seal, after impinging upon the coupling adaptor diaphragm and contacting the diaphragm cutter, and having successively pierced the diaphragm and the diaphragm seal, permitting the flow of the pre-charged gaseous medium, from the line set and female coupling, into the coupling adaptor and the male connector.

In a variation thereof, the female coupling includes a rotatable nut member secured to the another end, the nut member having an internal fastening member; the coupling adaptor second portion including an external fastening member, with the joining of the fastening members providing the operative interconnection between the female coupling and second portion.

In another variation thereof, the male connector one end includes an external fastening member and the coupling adaptor first portion first central cavity includes an internal fastening member, with the joining of the fastening members operatively interconnecting the first cavity with the male connector one end.

In further variations thereof, the diaphragm is a metallic diaphragm and the first and second cavities are coaxial and are multi-bore cavities.

Another embodiment of this invention pertains to a generally tubular coupling adaptor operatively interposed between a generally tubular male connector and a sealed, generally tubular female coupling having, on an end, a line set pre-charged with a refrigerant medium; the adaptor comprising: a first portion having a first central cavity, the first central cavity including an annular, radially inwardly-directed shoulder portion having a peripheral knife edge; and a second portion, adjoining the first portion, having a second central cavity in communication with the first central cavity, a diaphragm cutter, proximate the first portion, axially extending into the second cavity, the second cavity also including a distal, flared, annular nose portion and an internal peripheral groove, intermediate the diaphragm cutter and the nose portion; and a diaphragm interposed within the second central cavity between the diaphragm cutter and the internal peripheral groove.

Versions thereof include: an elastomeric sealing member retained within the peripheral groove; the first central cavity including an internal fastening member; the second portion further including an external fastening member; the first and second cavities being coaxial; at least one of the first and second cavities being multi-bore cavities; the diaphragm being a metallic diaphragm; the first portion taking the form of a female portion; and the second portion taking the form of a male portion.

In another version, the tubular male connector includes a flared surface portion on one end, with the flared surface portion being operatively connected with the first portion first cavity, the peripheral knife edge being sealingly embedded within the flared surface portion, thus providing a fluid-tight metal-to-metal seal between the male connector and the first portion.

In a further version, the tubular female coupling includes first and second ends, with the second end being generally cylindrical and being sealed with a metallic diaphragm seal and the first end being operatively interconnected with the line set pre-charged with the refrigerant medium; the coupling adaptor further including an elastomeric sealing member retained within the peripheral groove; the female coupling member having an operatively sealed interconnection with the second portion central cavity via the sealing member having a sealing relationship with the generally cylindrical end of the female coupling.

In a variation of the previous version, the tubular female coupling further includes, intermediate the first and second ends, at least one annular exterior stepped portion; the second portion flared, annular nose portion being sealingly embedded in the at least one annular exterior stepped portion, thus providing a metal-to-metal seal between the second portion and the female coupling.

In another variation of the previous version, the female coupling second end, together with the diaphragm seal, after impinging upon the coupling adaptor diaphragm and contacting the diaphragm cutter, and having successively pierced the diaphragm and the diaphragm seal, permits the flow of the refrigerant medium, from the line set and female coupling, into the coupling adaptor and the male connector.

Another embodiment of the present invention pertains to a method of assembling a coupling for an air control system, the coupling including a generally tubular male connector, a generally tubular, sealed female coupling having a line set pre-charged with a gaseous medium under pressure, and a generally tubular coupling adaptor, the method comprising the steps of: a. providing a fluid-tight metal-to-metal seal between the flared end surface on one end of the male connector and a peripheral knife edge surface within a first cavity of a first end portion of the coupling adaptor; and b. achieving a fluid tight seal between the female coupling and a second cavity of a second end portion of the coupling adaptor, with the fluid-tight seal being accomplished via: i. positioning an elastomeric sealing member, located within the second cavity in a sealing relationship around a tubular portion of the female coupling; ii. impinging an annular flared nose portion, on the second end portion of the coupling adaptor, against and into an annular coupling step on the female coupler for producing a metal-to-metal seal between the second end portion and the female coupling; and iii. contacting and successively piercing, via a diaphragm cutter within the second cavity, a diaphragm seal, on an end of the female coupling and a diaphragm located within the second cavity, thereby permitting the flow of the pre-charged gaseous medium into the coupling adaptor and the male connector.

The previously-described advantages and features, as well as other advantages and features, will become readily apparent from the detailed description of the preferred embodiments that follow.

### BRIEF DESCRIPTION OF THE DRAWINGS

FIG. 1a is a top plan view of a prior art male SAE 45 degree flare connector;

FIG. 1b is a longitudinal, vertical, sectional view of the prior art flare connector of FIG. 1a;

FIG. 2a is a top plan view of a prior art coupling adaptor;

FIG. 2b is a longitudinal, vertical, sectional view of the prior art coupling adaptor of FIG. 2a;

FIG. 3a is a top plan view of a prior art coupling comprised of the combination of the flare connector of FIG. 1a with the coupling adaptor of FIG. 2a;

FIG. 3b is a longitudinal, vertical, sectional view of the prior art coupling of FIG. 3a;

FIG. 4a is a top plan view of a prior art flare connector, similar to that of the flare connector of FIG. 1a;

FIG. 4b is a longitudinal, vertical, sectional view of the prior art flare connector of FIG. 4a;

FIG. 5a is a top plan view of the coupling adaptor of the present invention;

FIG. 5b is a longitudinal, vertical, sectional view of the coupling adaptor of FIG. 5a;

FIG. 6a is a top plan view of the subassembly of the flare connector of FIG. 4a with the coupling adaptor of FIG. 5a;

FIG. 6b is a longitudinal, vertical, sectional view of the subassembly of FIG. 6a ;

FIG. 7a is a top plan view of a prior art female coupling, sealingly attached to a pre-charged line set;

FIG. 7b is a longitudinal, vertical, sectional view of the female coupling and line set of FIG. 7a;

FIG. 8a is a top plan view of the coupling of the present invention comprised of the flare connector of FIG. 4a and the coupling adaptor of FIG. 5a, with the female coupling and line set of FIG. 7a; and

FIG. 8b is a longitudinal, vertical, sectional view of the coupling of the present invention shown in FIG. 8a.

### DETAILED DESCRIPTION OF THE INVENTION

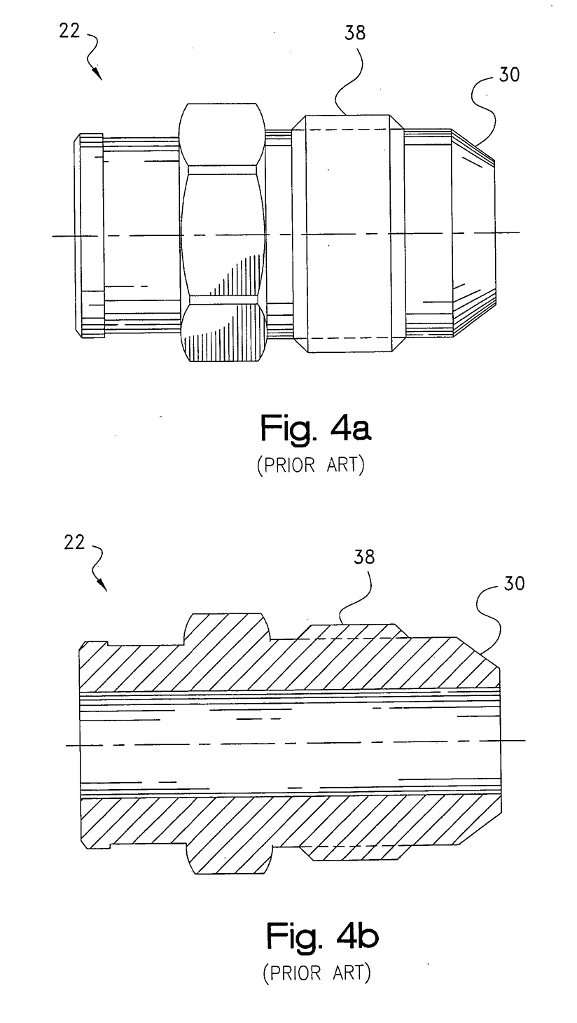

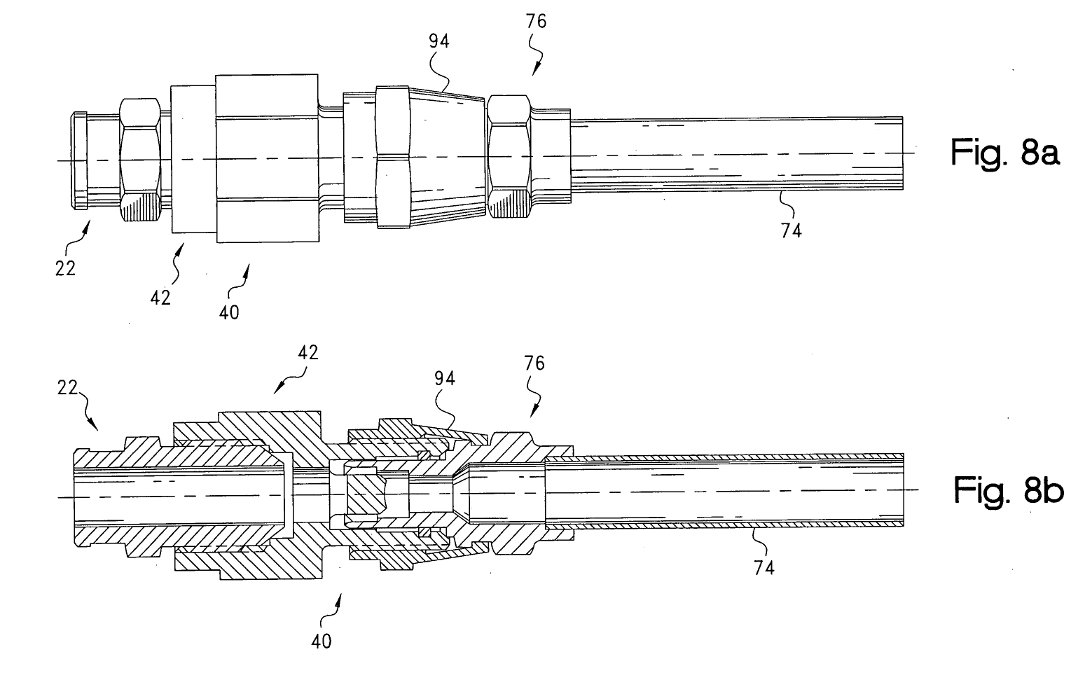

Turning now to the present invention, it relates to couplers or coupling assemblies used, for example, in refrigeration/air conditioning systems. Referring to FIGS. 4a to 8b, and initially specifically to FIGS. 8a, 8b, a coupling assembly 40, according to the present invention, is illustrated therein.

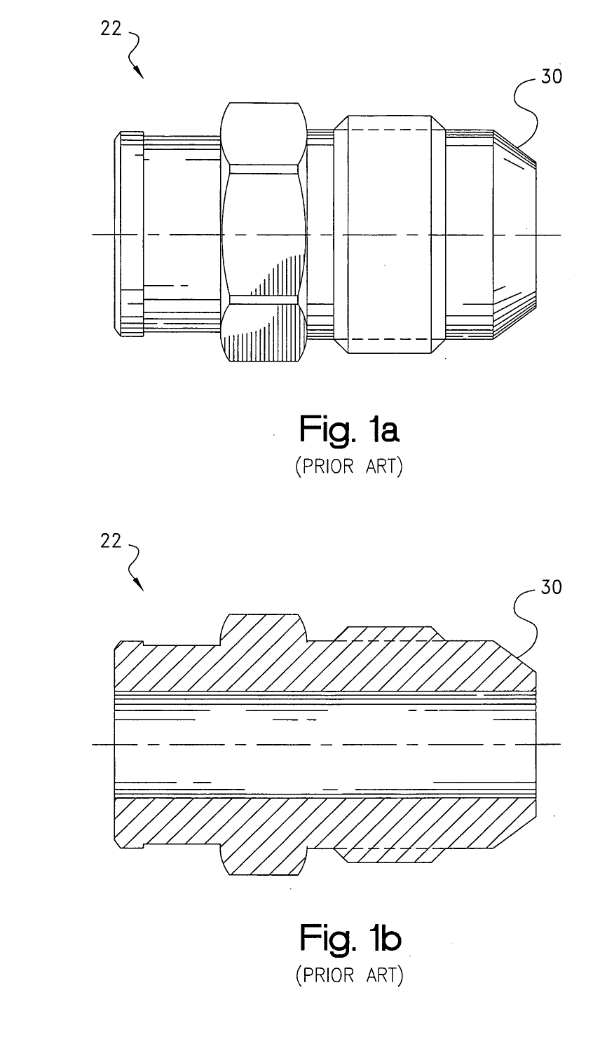

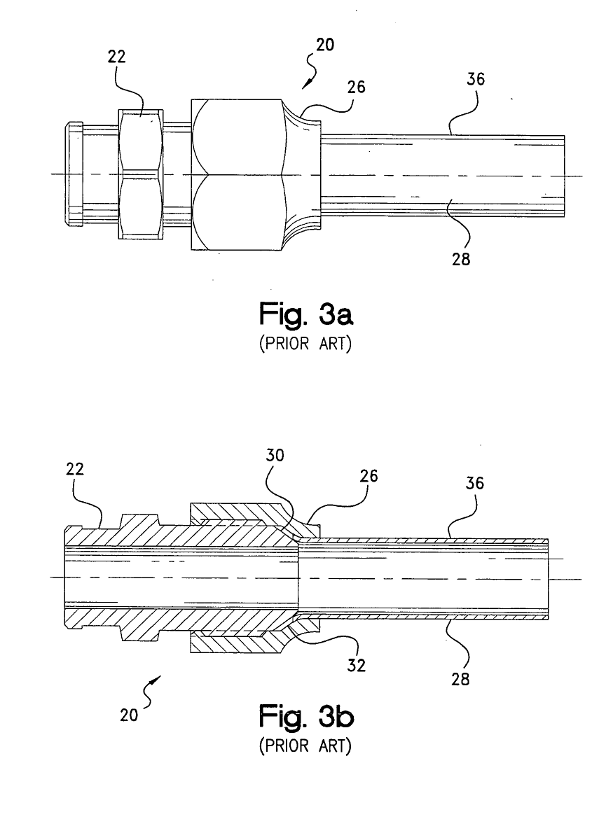

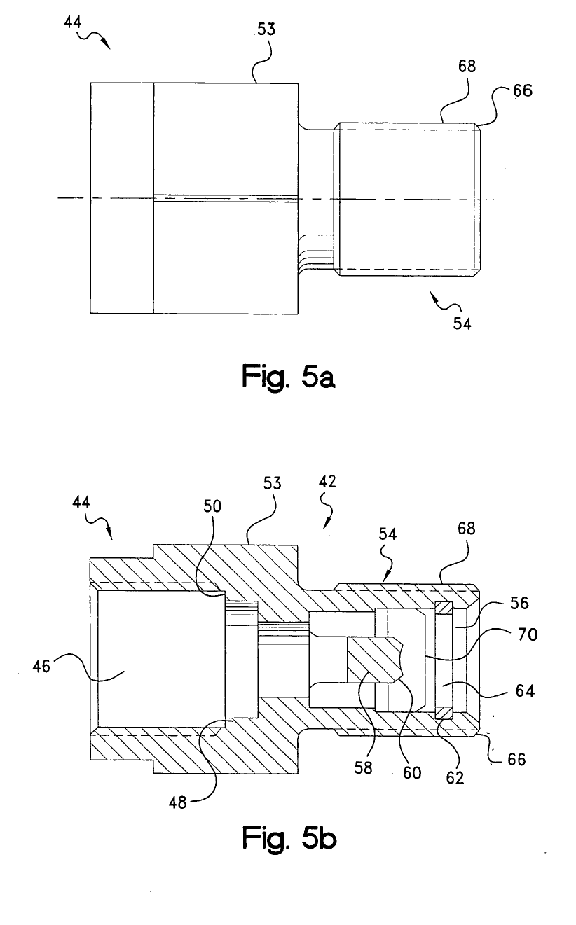

Coupler or coupling assembly 40 is comprised of male SAE 45 degree flare connector 22, already previously describe relative to FIGS. 1a to 3b, a unique metallic coupling adaptor 42 and a known female coupling 76 having a sealingly attached pre-charged line set 74. As shown in detail in FIGS. 5a, 5b, metallic coupling adaptor 42, which is generally tubular in shape, is comprised of a first or female portion 44 having a coaxial multi-bore cavity 46 that includes an annular inwardly-directed shoulder portion 48 having a peripheral inner knife edge 50. Cavity 46 opens into a second or male portion 54 of coupling adaptor 42 also having a multi-bore cavity 56, coaxial and in communication with first portion cavity 46. Male portion 54 also includes, within cavity 56, a central axially-extending protuberance or raised boss portion 58 that includes, at its outer edge, a diaphragm cutter portion 60 of any conventional desired shape. In addition, male portion 54 also includes an internal peripheral groove 62 adapted to receive a peripheral annular seal 64, such as a flexible O-ring 64. Furthermore, axially interposed between seal 64 and cutter portion 60 is a transverse, preferably metallic, diaphragm 70 that functions as a safety shield during assembly. Finally, male portion 54 is also provided with a contoured or flared outer nose portion 66 and an external fastening member 68, such as a threaded portion. Female portion 44 is provided, within cavity 46, with an internal fastening member 52, such as a threaded portion, and an external tool-attachment shape 53, such as in the form of a hexagon.

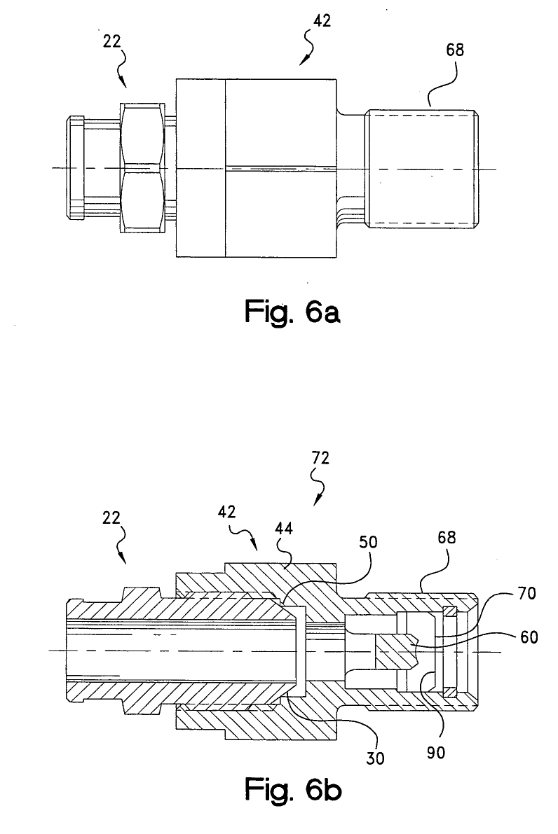

Moving now to FIGS. 6a, 6b, illustrated therein is a subassembly 72, comprised of 45 degree flare connector 22 assembled or united with coupling adaptor 42. Specifically, an exterior portion of flare connector 22, having an exterior fastening member 38, such as a threaded portion, is operatively interconnected with the interior fastening member 52 of coupling member female portion 44. As best seen in FIG. 6b, the 45 degree conical end surface 30 of flare connector 22 impinges upon and sealingly embeds knife edge 50 of coupling member female portion 44, thereby providing a fluid-tight metal-to-metal seal between flare connector 22 and coupling adaptor female portion 44.

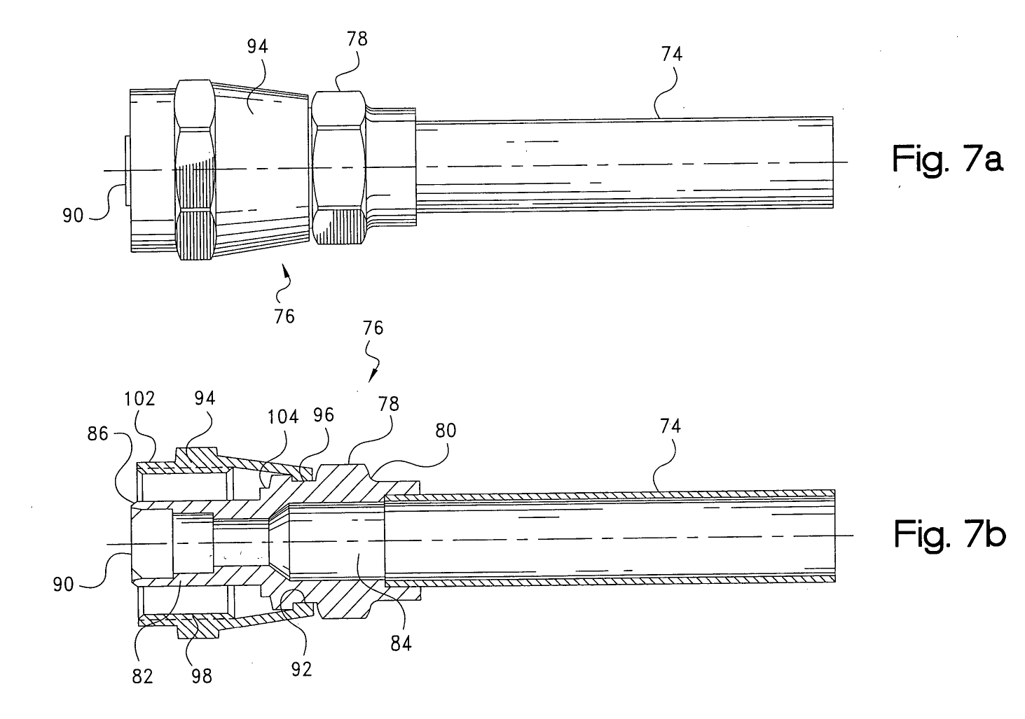

Continuing with FIGS. 7a, 7b, illustrated therein is a known metallic female coupling, such as the 5780 series female coupling produced by the Parker-Hannifin Corporation, generally tubular in shape, having a body 78 with a stepped rear bore portion 80 that sealingly receives a pre-charged line set 74. A front portion 82 of body 78 includes a multi-bore cavity 84 coaxial with bore portion 80 and a reduced diameter contoured nose portion 86 whose leading outer edge is provided with a, preferably metallic, diaphragm seal 90 that functions to sealingly retain the refrigerant medium within pre-charged line set 74. Body 78 is also provided with an external groove 92 whose function it is to axially restrain and rotatably retain an inner end 96 of a generally tubular nut member 94 so that same can rotate relative to body 78. An inner surface portion of nut member 94 is provided with a fastening member 98, such as an internally threaded portion, for operative interconnection with coupling adaptor external fastening member 68.

The external surface 102 of body front portion 82 is generally cylindrical in shape and has an outside diameter that will provide a suitable sealing surface for the inside diameter of coupling adaptor peripheral seal 64. In addition, body 78 includes a plurality of concentric peripheral annular step portions 104 having outside diameters sized to permit impingement and embedding with coupling adaptor contoured outer nose portion 66, thereby producing multiple metal-to-metal seals between coupling adaptor 42 and female coupling 76.

Turning now to FIGS. 8a, 8b, shown therein is the completed joining of coupling assembly 40 of the present invention, generally comprised of the combination of flare connector 2 and coupling adaptor 42, with female coupling 76 and line set 74. Specifically, during the attachment of subassembly 72 (FIGS. 6a, 6b), comprised of flare connector 22 and coupling adaptor 42, to female coupling 76 (FIGS. 7a, 7b), which results in the assembled coupling 20 of FIGS. 8a, 8b. During assembly, female coupling front portion 82 starts to enter into coupling adaptor cavity 56, with female coupling nose portion 86, together with its diaphragm seal 90, initially making contact with coupling adaptor diaphragm 70 and displacing the latter axially inwardly until there is contact with diaphragm cutter 60. Thereafter, coupling adaptor protrusion 58 and its diaphragm cutter 60 successively pierces coupling adaptor diaphragm 70 and female coupling diaphragm seal 90, thereby permitting the flow of refrigerant medium into coupling adaptor 42 and male flare connector 22. Substantially simultaneously with the noted piercings, coupling adaptor contoured nose portion 66 impinges upon female coupling 76 annular step portions 104, thereby producing multiple metal-to-metal concentric seals. In addition, prior to the noted diaphragm piercing and the production of the noted metal-to-metal seals, coupling adaptor peripheral seal 64 has already entered into a sealing relationship with female coupler external cylindrical surface 102.

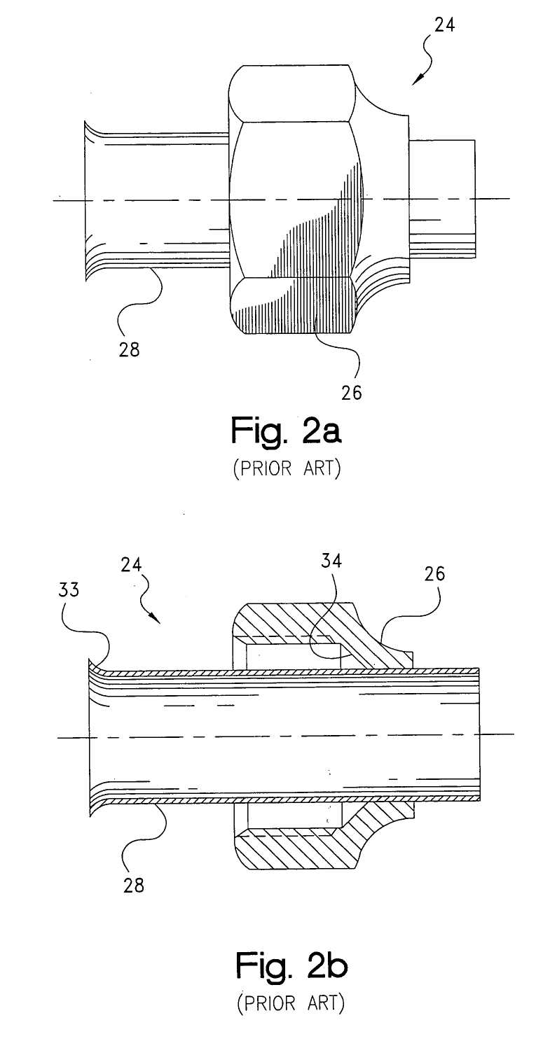

It should thus be clearly understood that the present invention not only eliminates the prior art requirement for the shaping of an end of copper tube 28 into a flare portion 32 (FIGS. 2a, 2b) but also eliminates both the evacuation and subsequent charging of the lines for installations. Instead, a pre-charged line set 74, which is attached to female coupling 54 and sealed with diaphragm seal 90, can be quickly and easily attached to coupling adaptor male portion 54, thus simplifying not only the installation process but also saving valuable labor time.

It is deemed that one of ordinary skill in the art will readily recognize that the present invention fills remaining needs in this art and will be able to affect various changes, substitutions of equivalents and various other aspects of the invention as described herein. Thus it is intended that the protection granted hereon be limited only by the scope of the appended claims and their equivalents.

1. In a coupler for air temperature control systems having:
a. an axially apertured, generally cylindrical, metallic male connector having two ends, with a flared surface portion on one end;
b. an axially apertured, generally cylindrical, metallic female coupling having two ends, with a line set pre-charged with a gaseous medium at one end, a diaphragm seal for retaining said gaseous medium at a distal portion of said another end, said another end also including a generally tubular portion and a plurality of concentric annular steps at a proximate portion thereof, said another end also having a rotatable nut member secured to and coaxial with said another end, wherein the improvement comprises
c. a generally tubular, metallic coupling adaptor, operatively connected between said male connector and said female coupling, said coupling adaptor including:
i. a female portion having a coaxial multi-bore first cavity, said first cavity including an annular, radially inwardly-directed shoulder portion having a peripheral knife edge, said male connector one end, together with said flared surface portion, being operatively interconnected with said female portion first cavity, said flared surface portion impinging upon and sealingly embedding said knife edge therein, thereby providing a fluid-tight metal-to-metal seal between said male connector and said female portion; and said coupling adaptor further including:
ii. a male portion, adjoining one end of said female portion, having a multi-bore second cavity, coaxial and in communication with said multi-bore first cavity, a central diaphragm cutter extending axially into said multi-bore second cavity, proximate said one end of said female portion, said male portion also including a distal, flared, annular nose portion, said multi-bore second cavity including an internal peripheral groove, located between said diaphragm cutter and said nose portion; an elastomeric sealing member retained in said peripheral groove; and a diaphragm interposed within said multi-bore second cavity, between said diaphragm cutter and said elastomeric sealing member; said female coupling having an operative interconnection with said male portion multi-bore second cavity, said interconnection including: said elastomeric sealing member achieving a sealing relationship with said generally tubular portion of said female coupling another end; said annular flared nose portion of said coupling adaptor male portion impinging upon and sealingly embedding at least one of said female coupling annular steps, thereby providing a fluid-tight metal-to-metal seal between said coupling adaptor male portion and said female coupling; and said female coupling one end, together with said diaphragm seal, impinging upon said coupling adaptor diaphragm, contacting said diaphragm cutter and successively piercing said coupling adaptor diaphragm and said female coupling diaphragm seal, thereby permitting the subsequent flow of said pre-charged gaseous medium into said coupling adaptor and said male connector.

2. The improved coupler for air temperature control systems of claim 1, wherein said coupling adaptor male portion includes an external fastening member and said female coupling rotatable member includes an internal fastening member, with the joining of said fastening members providing the operative interconnection between said female coupling and said male portion multi-bore second cavity.

3. The improved coupler for air temperature control systems of claim 1, wherein said male connector one end includes an external fastening member and said coupling adapter female portion multi-bore first cavity includes an internal fastening member, with the joining of said fastening members operatively interconnecting said first cavity with said male connector one end.

4. The improved coupler for air temperature control systems of claim 1, wherein said diaphragm is a metallic diaphragm.

5. A generally tubular coupling adaptor operatively interconnected between a generally tubular male connector, having a flared surface portion on one end, and a generally tubular female coupling, having two ends, with one generally cylindrical end being sealed with a metallic diaphragm, another end being operatively connected with a line set pre-charged with a gaseous medium and, intermediate said two ends, having at least one exterior annular stepped portion, said coupling adaptor comprising:
a. a first portion having a first central cavity, said first cavity including an annular, radially-inwardly-directed shoulder portion having a peripheral knife edge, said male connecter flared surface portion being operatively interconnected with said first portion first cavity, said peripheral knife edge being sealingly embedded within said flared surface portion, thus providing a fluid-tight metal-to-metal seal between said male connector and said first portion; and
b. a second portion, adjoining one end of said first portion, having a second central cavity in communication with said first cavity, a diaphragm cutter, proximate said first portion, axially extending into said second cavity, said second portion also including a distal, flared, annular nose portion, and an internal peripheral groove, intermediate said diaphragm cutter and said nose portion; an elastomeric sealing member retained within said peripheral groove; and a diaphragm interposed within said second central cavity between said diaphragm cutter and said sealing member, said female coupling having an operatively sealed interconnection with said second portion second central cavity via said sealing member having a sealing relationship with said generally cylindrical end of said female coupling; with said flared, annular nose portion being sealingly embedded in said at least one exterior annular stepped portion, thereby providing a metal-to-metal seal between said second portion and said female coupling; and said female coupling one end, together with said diaphragm seal, after impinging upon said coupling adaptor diaphragm and contacting said diaphragm cutter, and having successively pierced said diaphragm and said diaphragm seal, permitting the flow of said pre-charged gaseous medium, from said line set and female coupling, into said coupling adaptor and said male connector.

6. The tubular coupling adaptor of claim 5, wherein said female coupling includes a rotatable nut member secured to said another end, said nut member having an internal fastening member; said coupling adaptor second portion including an external fastening member, with the joining of said fastening members providing said operative interconnection between said female coupling and second portion.

7. The tubular coupling adaptor of claim 5, wherein said male connector one end includes an external fastening member and said coupling adaptor first portion first central cavity includes an internal fastening member, with the joining of said fastening members operatively interconnecting said first cavity with said male connector one end.

8. The tubular coupling adaptor of claim 5, wherein said diaphragm is a metallic diaphragm.

9. The tubular coupling adaptor of claim 5, wherein said first and second cavities are coaxial and are multi-bore cavities.

10. A generally tubular coupling adaptor operatively interposed between a generally tubular male connector and a sealed, generally tubular female coupling having, on an end, a line set pre-charged with a refrigerant medium; said adaptor comprising:
a. a first portion having a first central cavity, said first central cavity including an annular, radially inwardly-directed shoulder portion having a peripheral knife edge; and
b. a second portion, adjoining said first portion, having a second central cavity in communication with said first central cavity, a diaphragm cutter, proximate said first portion, axially extending into said second cavity, said second cavity also including a distal, flared, annular nose portion and an internal peripheral groove, intermediate said diaphragm cutter and said nose portion; and a diaphragm interposed within said second central cavity between said diaphragm cutter and said internal peripheral groove.

11. The tubular coupling adaptor of claim 10, further including an elastomeric sealing member retained within said peripheral groove.

12. The tubular coupling adaptor of claim 10, wherein said first central cavity further includes an internal fastening member.

13. The tubular coupling adaptor of claim 10, wherein said second portion further includes an external fastening member.

14. The tubular coupling adaptor of claim 10, wherein said first and second cavities are coaxial.

15. The tubular coupling adaptor of claim 10, wherein at least one of said first and second cavities are multi-bore cavities.

16. The tubular coupling adaptor of claim 10, wherein said diaphragm is a metallic diaphragm.

17. The tubular coupling adaptor of claim 10, wherein said first portion takes the form of a female portion.

18. The tubular coupling adaptor of claim 10, wherein said second portion takes the form of a male portion.

19. The tubular coupling adaptor of claim 10, wherein said tubular male connector includes a flared surface portion on one end, with said flared surface portion being operatively connected with said first portion first cavity, said peripheral knife edge being sealingly embedded within said flared surface portion, thus providing a fluid-tight metal-to-metal seal between said male connector and said first portion.

20. The tubular coupling adaptor of claim 10, wherein said tubular female coupling includes first and second ends, with said second end being generally cylindrical and being sealed with a metallic diaphragm seal and said first end being operatively interconnected with said line set pre-charged with said refrigerant medium; said coupling adaptor further including an elastomeric sealing member retained within said peripheral groove; said female coupling member having an operatively sealed interconnection with said second portion central cavity via said sealing member having a sealing relationship with said generally cylindrical end of said female coupling.

21. The tubular coupling adaptor of claim 20, wherein said tubular female coupling further includes, intermediate said first and second ends, at least one annular exterior stepped portion; said second portion flared, annular nose portion being sealingly embedded in said at least one annular exterior stepped portion, thus providing a metal-to-metal seal between said second portion and said female coupling.

22. The tubular coupling adaptor of claim 21, wherein said female coupling second end, together with said diaphragm seal, after impinging upon said coupling adaptor diaphragm and contacting said diaphragm cutter, and having successively pierced said diaphragm and said diaphragm seal, permits the flow of said refrigerant medium, from said line set and female coupling, into said coupling adaptor and said male connector.

23. A method of assembling a coupling for an air control system, said coupling including a generally tubular male connector, a generally tubular, sealed female coupling having a line set pre-charged with a gaseous medium under pressure, and a generally tubular coupling adaptor, said method comprising the steps of:
a. providing a fluid-tight metal-to-metal seal between the flared end surface on one end of said male connector and a peripheral knife edge surface within a first cavity of a first end portion of said coupling adaptor; and
b. achieving a fluid tight seal between said female coupling and a second cavity of a second end portion of said coupling adaptor, with said fluid-tight seal being accomplished via:
i. positioning an elastomeric sealing member, located within said second cavity in a sealing relationship around a tubular portion of said female coupling;
ii. impinging an annular flared nose portion, on said second end portion of said coupling adaptor, against and into an annular coupling step on said female coupler for producing a metal-to-metal seal between said second end portion and said female coupling; and
iii. contacting and successively piercing, via a diaphragm cutter within said second cavity, a diaphragm seal, on an end of said female coupling and a diaphragm located within said second cavity, thereby permitting the flow of said pre-charged gaseous medium into said coupling adaptor and said male connector.
